(19) United States
(12) Patent Application Publication
(10) Pub. No.: US 2024/0177190 A1
(43) Pub. Date: May 30, 2024

(54) OPTIMIZING COMMUNICATION CHANNELS FOR USER COMMUNICATIONS BASED ON IMPROVED CHANNEL ATTRIBUTIONS

(71) Applicant: Accenture Global Solutions Limited, Dublin 4 (IE)

(72) Inventors: Parmita Biswas, Bengaluru (IN); Anoop Kumar Gopinatha, Issaquah, WA (US); Manish Pasrija, Faridabad (IN)

(21) Appl. No.: 18/070,755

(22) Filed: Nov. 29, 2022

(51) Int. Cl. G06Q 30/0242

(52) U.S. Cl. CPC G06Q 30/0243

(57) ABSTRACT

Methods and systems to optimize communication channels for use in presenting and/or generating user communications are provided. In one aspect, improved attributions may be generated by analyzing historical user communication and communication data to identify unique channels, possible combinations of unique channels, and/or sequences of user communications that correspond to the same occurrence of a desired user outcome. The sequences and possible channel combinations may then be used to generate a model of how different channel combinations impact the likelihood of the desired user outcomes. Marginal contributions for the unique channels may be determined based on this mode. The marginal contributions and the model may both be used to generate final attributions for the unique channels. In certain instances, the final attributions may then be used to generate improved content sequences and/or budgets for content delivery to user devices.

### BACKGROUND

Modern Internet usage and media consumption has greatly increased the number of potential communication channels by which users may be contacted or communicate. At the same time, the ability of modern media platforms (e.g., social media platforms, online content platforms) to generate user communications has greatly expanded. For example, a typical purchase by an individual is commonly preceded by as many as 20 or more unique user communications (e.g., advertisement impressions, content presentations). The greatly diversified user communication environment has significantly increased the complexity in generating attributions for different communication channels used to communicate with a user. Existing systems take a simplified approach to try and bypass this complexity. For example, existing attribution systems may generate attributions primarily to the first communication with a user, the last communication with the user, or may evenly distribute attributions to all channels used to communicate with the user. But such systems are often inaccurate because of this simplified approach and are unable to accurately determine which communication channels and sequences of communication channels are actually most effective.

### SUMMARY

The present disclosure presents new and innovative systems and methods to optimize communication channels for use in presenting and/or generating user communications. Specifically, the present disclosure discusses techniques for improved attribution of communications across multiple communication channels in bringing about certain user outcomes. In particular, improved attributions may be generated by analyzing historical user communication and communication data to identify which unique channels were used for customer communications, such as communications that resulted in one or more desired user outcomes. Possible combinations of the various unique channels may then be generated based on the identified unique channels. The communication data may also be analyzed to generate sequences of user communications that correspond to the same occurrence of a desired user outcome. These sequences and the possible channel combinations may then be analyzed to generate a model of how different channel combinations impact the likelihood of the desired user outcomes. The model may then be used to determine marginal contributions for the channels. In particular, marginal contributions may be computed as Shapley values corresponding to the unique channels. The marginal contributions and the model may both be used to generate final attributions for the unique channels. The final attributions may then be used to generate improved content sequences and/or budgets for content delivery to user devices. The improved content sequences and recommendations may then be used to optimize communication with one or more user devices.

In some aspects, the techniques described herein relate to a method including: receiving data regarding user communications with content associated with user outcomes; identifying, within the data, unique channels through which the content was presented; determining possible channel combinations of the unique channels; generating a first model of user outcome impacts for at least a subset of the possible channel combinations; determining, for the unique channels, marginal contributions to the user outcomes based on the first model; determining final outcome attributions for the unique channels based on the marginal contributions and the first model; and transmitting at least one communication to a user based on the final outcome attributions.

In some aspects, the techniques described herein relate to a method wherein, for each respective unique channel, the marginal contributions represent a percentage of credit attributable to the respective unique channel for the user outcomes.

In some aspects, the techniques described herein relate to a method wherein the marginal contributions are determined as Shapley values for the unique channels.

In some aspects, the techniques described herein relate to a method wherein generating the first model further includes determining conversion ratios for the unique channels, wherein the conversion ratios represent a percentage of the user outcomes that include at least a subset of the channel combinations.

In some aspects, the techniques described herein relate to a method wherein the conversion ratios are stored as a conversion matrix, which is created by: identifying, for each user outcome, which channel combination is indicated by corresponding user communications; determining, for each respective unique channel, the conversion ratio for the respective channel combination based on a total number of times the respective channel combination is identified; and adding, for each respective channel combination, an entry to the conversion matrix indicating the conversion ratio for the respective channel combination.

In some aspects, the techniques described herein relate to a method wherein generating the first model further includes: creating a coalition matrix based on the user communications, wherein the coalition matrix represents how frequently at least one subset of the possible channel combinations occur within the data.

In some aspects, the techniques described herein relate to a method wherein determining the coalition matrix includes, for each user outcome within the data, adding a binary indicator to the coalition matrix for each unique channel and channel combination present within corresponding user communications.

In some aspects, the techniques described herein relate to a method wherein at least one subset of the user communications are grouped into communication sequences, and wherein each communication sequence includes multiple user communications that correspond to a single occurrence of a desired user outcome.

In some aspects, the techniques described herein relate to a method wherein transmitting the at least one communication to the user includes: computing a budget allocation for future user content communications based on cost data for the unique channels and the final outcome attributions, and transmitting the budget allocation to the user.

In some aspects, the techniques described herein relate to a method wherein transmitting at least one communication to the user includes: determining an optimized channel sequence for the unique channels to facilitate a desired user outcome, and transmitting the optimized sequence to the user.

In some aspects, the techniques described herein relate to a method wherein the optimized channel sequence is used to schedule content delivery to a user device.

In some aspects, the techniques described herein relate to a method wherein the content includes at least one of video content, image content, text content, and/or audio content.

In some aspects, the techniques described herein relate to a method wherein the user outcomes include at least one physical goods purchase, a digital goods purchase, a digital service subscription, and/or a user sign-up.

In some aspects, the techniques described herein relate to a method wherein the data includes communication details for corresponding content, product data for products purchased, and demographic data for associated users.

In some aspects, the techniques described herein relate to a method wherein a unique channel represents an online medium in which content is presented to users.

In some aspects, the techniques described herein relate to a method wherein the unique channels include at least one social media timeline, content platform, search engine result, and/or website content.

In some aspects, the techniques described herein relate to a method wherein the user outcomes concern at least one of the same product, the same brand, and/or the same advertising campaign.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes and not to limit the scope of the disclosed subject matter.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

For a more complete understanding of the present disclosure, reference is now made to the following descriptions taken in conjunction with the accompanying drawings, in which:

FIG. 1 illustrates a block diagram of a system for determining attributions of user outcomes for multiple communication channels according to an exemplary embodiment of the present disclosure;

FIG. 2A illustrates a block diagram of a database storing user communication data according to an exemplary embodiment of the present disclosure;

FIG. 2B illustrates a block diagram of user communication data according to an exemplary embodiment of the present disclosure;

FIG. 2C illustrates a block diagram of a communication analysis engine for analyzing user communication data according to an exemplary embodiment of the present disclosure;

FIG. 2D illustrates a block diagram of a communication model for determining conversions and/or coalitions of multiple communication channels according to an exemplary embodiment of the present disclosure;

FIG. 2E illustrates a block diagram of an attribution model for determining attributions for multiple communication channels according to an exemplary embodiment of the present disclosure;

FIG. 3 illustrates a flow diagram of operations to determine attributions of user outcomes for multiple communication channels according to an exemplary embodiment of the present disclosure; and

FIG. 4 illustrates a flow diagram of a method to determine attributions of user outcomes according to an exemplary embodiment of the present disclosure.

### DETAILED DESCRIPTION

Aspects of the present disclosure provide systems, methods, and computer-readable storage media that support optimization of communications transmitted over a plurality of communication channels. Specifically, the present disclosure discusses techniques for improved attribution of communications across multiple communication channels in bringing about certain user outcomes. Improved content sequences and recommendations are then generated based on these improved attributions, which may then be used to optimize communication with one or more user devices. The improved communications reduce the overall bandwidth necessary to communicate with users (i.e., by reducing the overall number of user communications and communications that occur) while potentially also reducing the overall cost of communication paid to communication channels for user communications. To generate the improved attributions, historical user communication and communication data are analyzed to identify which unique channels were used for user communications that resulted in one or more desired user outcomes. Sequences of user communications that resulted in the desired user outcomes may then be used to generate a model of how different channel combinations impact the likelihood of the desired user outcomes. The model may then be used to determine marginal contributions for the channels. The marginal contributions and the model may both be used to generate final attributions for the unique channels. The final attributions may then be used to generate improved content sequences and/or budgets for content delivery to user devices.

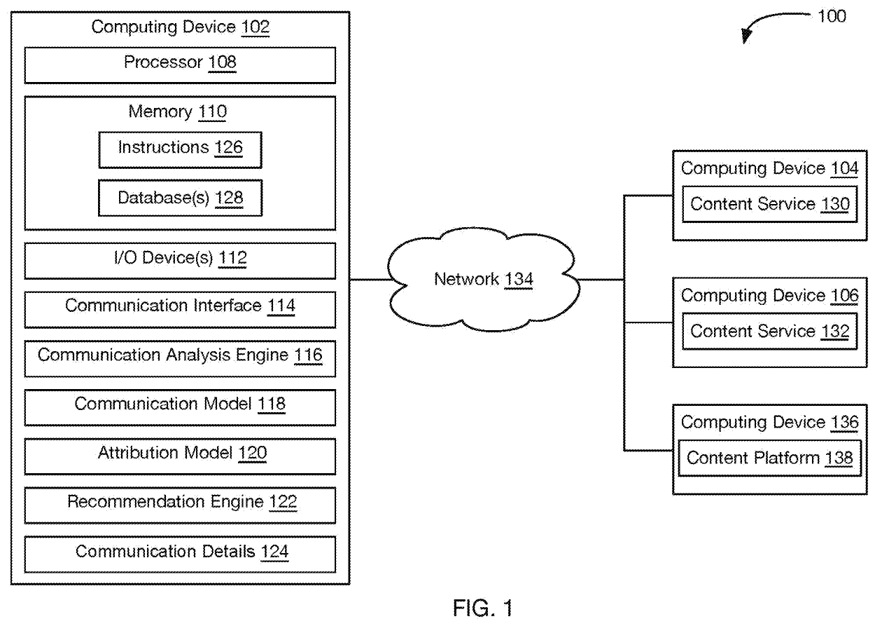

FIG. 1 illustrates a block diagram of a system 100 for determining attributions of user outcomes for multiple communication channels according to an exemplary embodiment of the present disclosure. The system 100 may be configured to optimize user communications provided to users via a variety of channels (e.g., communication channels). For example, the communication channels may include one or more of email communications, audio communications, text communications, video communications, short message service (SMS) communications, and/or third-party communication platforms (e.g., social media platforms, multimedia streaming platforms, and the like). In certain instances, user communications may occur via communication channels happening in real time or near-real time. For example, user communications may occur via real-time text communication services (e.g., messaging services, chat services), real time video and/or audio services (e.g., video conferencing services, video streaming services, audio streaming services, etc.), and/or real time audio communication services (e.g., teleconferencing services, automated voice response (AVR) services, and the like). Additionally or alternatively, user communications may occur via asynchronous communication channels. For example, one or more communication channels may present predetermined and/or prerecorded content for user consumption. For example, user communications may occur via one or more content platforms (e.g., video platforms, image platforms, text platforms, and/or combinations thereof). In certain instances, the content platforms may present advertisements within user advertisement impression slots along with prerecorded and/or predetermined content. For example, user communications may include advertisements in social media timelines, advertisements that occur during advertisement slots within other content (e.g., pre-roll ads, mid-roll ads, post-roll ads), banner advertisements, and the like. In additional or alternative implementations, user actions may be part of the native content presented via the platform, for example, sponsored content, native product placement within content, product summaries, product reviews, product comparisons, native advertising, and the like. In various implementations, user communications may occur via one or more of Facebook®, Instagram®, TikTok®, YouTube®, Twitter®, email advertisements, search result advertisements, banner advertisements, and the like.

In various aspects, optimizing the use of various communication channels for the purposes of optimizing user communications may include determining attributions for multiple communication channels in various types of user outcomes. In particular, although content and other user communications can be presented to users across multiple channels, it currently remains difficult to accurately or meaningfully attribute the effect that each user communication (e.g., each piece of content) and/or each communication channel had on triggering or otherwise encouraging the user to take one or more actions, as reflected in the desired user outcome. To remedy these deficiencies, the computing device 102 may compute multiple models that help indicate how frequently certain communication channels were used and how frequently particular channel combinations occurred and ultimately resulted in a desired outcome.

For example, a communication model may be generated based on received user communication data. The communication model may include models of how individual communication channels and/or how various combinations of communication channels affect the likelihood of a desired user outcome (e.g., a sale of goods or products, a newsletter sign-up, a positive product review, or other user communications).

An attribution model may then be formed based at least in part on the communication model. The attribution model may include the final attributions for how various channels affect the likelihood of the desired user outcomes. The final attributions may be computed based on marginal contributions for the communication channels. The final attributions may then be used to select between communication channels in future user communication and user communication processes. This may help improve the results of communications with various users, reducing the overall number of user communications required (and the associated communication computing and networking overload). Exemplary aspects of attributing user outcomes and optimizing the use of communication channels by the system 100 are described in more detail below.

As shown in FIG. 1, the system 100 includes a computing device 102 communicatively coupled to one or more computing devices 104, 106, 136 via one or more networks 134. The computing devices 104, 106, 136 may be one or more computing devices associated with users or individuals. For example, the computing devices 104, 106, 136 may be implemented by one or more of a desktop computing device, a laptop computing device, a personal computing device, a tablet computing device, a mobile device (e.g., a smart phone, a tablet, a personal digital assistant (PDA), a wearable device, and the like), a server, a virtual reality (VR) device, an augmented reality (AR) device, an extended reality (XR) device, a vehicle (or a component thereof), an entertainment system, other computing devices, or a combination thereof, as non-limiting examples. In additional or alternative implementations, the computing devices 104, 106, 136 may be implemented by one or more enterprise computing devices, such as server computing devices, cloud computing devices, virtualized computing devices, and the like. In certain implementations, the computing device 104, 106 may be implemented by enterprise computing devices and the computing device 136 may be implemented by personal computing devices.

The computing devices 104, 106 may implement one or more content services 130, 132. The content services 130, 132 may be configured to provide content to computing devices (e.g., such as the computing device 136) via one or more communication channels over the network 134. For example, the computing devices 104, 106 may provide one or more of text content, audio content, image content, video content, and the like via one or more of the above-discussed communication channels. In certain implementations, the computing devices 104, 106 may be associated with the same content services 130, 132. In additional or alternative implementations, the computing devices 104, 106 may be associated with and provided content for one or more different content services. For example, in various implementations, each content service and/or communication channel may include one or more associated computing devices that are configured to serve content to users via corresponding communication channels (e.g., via computing devices 102). In one specific implementation, the content service 130 may provide image content for a social media service (e.g., Instagram®) and the content service 132 may provide video content for an online video platform (e.g., YouTube®).

The computing device 136 may implement a content platform 138 that may be used to access content provided by the one or more content services 130, 132. For example, the content platform 138 may be a software application configured to execute on user devices (e.g., the computing device 136) to receive and display or otherwise reproduce content received from the content services 130, 132 on the user devices. In particular, the content platform 138 may be configured to communicate with the content services 130, 132 via the one or more networks 134. In certain instances, the computing device 136 may be associated with individual users (e.g., individual users of the content platform 138). In such instances, the user communications may occur via computing devices 136 that are implementing or otherwise accessing content platforms 138.

The computing device 102 may be implemented by personal or enterprise computing devices. The computing device 102 includes one or more processors 108, a memory 110, one or more input/output (I/O) devices 112, and one or more communication interfaces 114. In some implementations, one or more of the components may be optional (e.g., the I/O devices 112), one or more additional components may be included in the computing device 102, or both. It is noted that functionalities described with reference to the computing device 102 are provided for purposes of illustration, rather than by way of limitation, and that the exemplary functionalities described herein may be provided via other types of computing resource deployments. For example, in some implementations, computing resources and functionality described in connection with the computing device 102 may be provided in a distributed system using multiple servers or other computing devices, or in a cloud-based system using computing resources and functionality provided by a cloud-based environment that is accessible over a network, such as cloud-computing logic associated with one of the one or more networks 134. To illustrate, one or more operations described herein with reference to the computing device 102 may be performed by one or more servers or the cloud-computing logic that communicates with one or more other devices.

The one or more processors 108 may include one or more microcontrollers, application specific integrated circuits (ASICs), field programmable gate arrays (FPGAs), central processing units (CPUs) having one or more processing cores, or other circuitry and logic configured to facilitate the operations of the computing device 102 in accordance with aspects of the present disclosure. The memory 110 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the computing device 102 may be stored in the memory 110 as instructions 126 that, when executed by the one or more processors 108, cause the one or more processors 108 to perform the operations described herein with respect to the computing device 102, as described in more detail below. Additionally, the memory 110 may be configured to store data and information at one or more databases 128. In some aspects, the one or more databases 128 may store historical data, such as user communication data. Exemplary aspects of the user communication data are described in more detail below.

In some implementations, the computing device 102 includes one or more input/output (I/O) devices 112. The I/O devices 112 may include one or more display devices, a keyboard, a stylus, one or more touchscreens, a mouse, a trackpad, a microphone, a camera, one or more speakers, haptic feedback devices, or other types of devices that enable a user to receive information from or provide information to the computing device 102. In some implementations, the computing device 102 is coupled to the display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the computing device 102. The computing device 102 may also include one or more communication interfaces 114, which may be configured to communicatively couple the computing device 102 to the one or more networks 134 via wired or wireless communication links established according to one or more communication protocols or standards (e.g., an Ethernet protocol, a transmission control protocol/Internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like).

As additionally shown in FIG. 1, the computing device 102 may also include a communication analysis engine 116, a communication model 118, an attribution model 120, a recommendation engine 122, and communication details 124. The communication details 124 may reflect details regarding a communication with a user via a communication channel. For example, the communication details 124 may include information regarding how the user communication occurred, a product identified within the communication, and/or information regarding the user with which the communication occurred. The communication details 124 may be stored within a database 128 within the computing device 102. The communication analysis engine 116 may be configured to analyze communication details 124 from multiple user communications (e.g., multiple communications with the same user, multiple communications with multiple users) across multiple communication channels. The communication analysis engine 116 may analyze the communication details 124 to identify unique channels within the communication details 124 and combinations of unique channels that resulted in one or more user outcomes. User outcomes may include positive or desired user outcomes, such as completing a sale of a good or service, completing a sign-up for a newsletter or customer loyalty program, receiving a positive product review from a user, receiving a social media follow from a user, and the like. In various implementations, the user outcomes may also include negative or undesired user outcomes, such as a user abandoning a sale, a user leaving a newsletter or customer loyalty program, receiving a negative product review from a user, having a user unfollow a social media account, and the like.

The communication model 118 may be generated to model user outcome impacts for various channel combinations (e.g., combinations of one or more unique channels identified within the communication details 124). The attribution model 120 may be further generated to model final outcome attributions for unique channels that were identified within the communication details 124. For example, the attribution model 120 may be created to generate final attributions of the effects or credit for each of the unique channels on a desired user outcome. Stated another way, the attribution model 120 quantifies the contribution of each unique communication channel of a sequence of communications with respect to achieving a particular user outcome. The recommendation engine 122 may be configured to generate one or more recommendations with respect to future communication channel utilization and sequences of communication channels based on the attribution model 120. For example, the recommendation engine 122 may recommend one or more of a budget for future user communication purchases, an optimized channel sequence, a recommended content schedule, a maximum bid to pay for content impressions on various communication channels, and the like. Such recommendations may be made with respect to a single user (e.g., an optimized sequence of communications to a specific user over particular communication channels, etc.), with respect to a campaign (e.g., optimized channel sequences, etc. for a particular subject matter, such as a product launch).

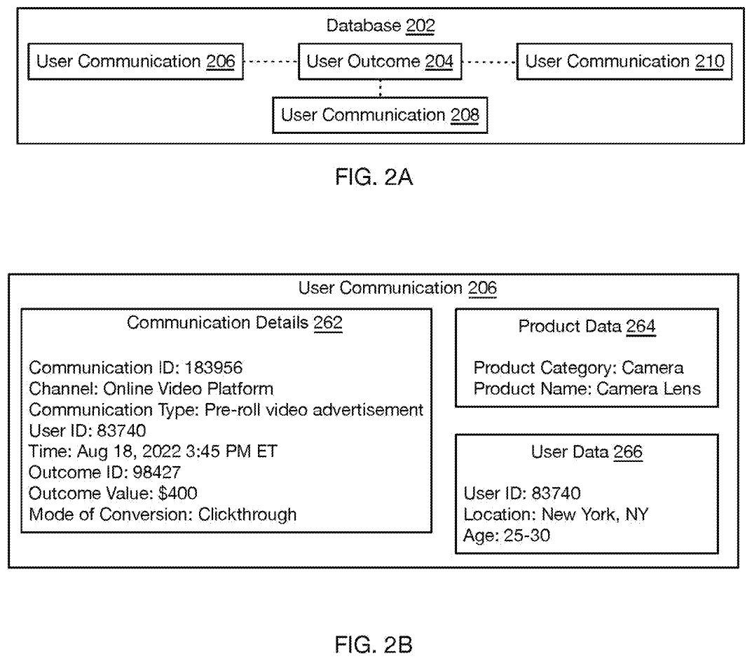

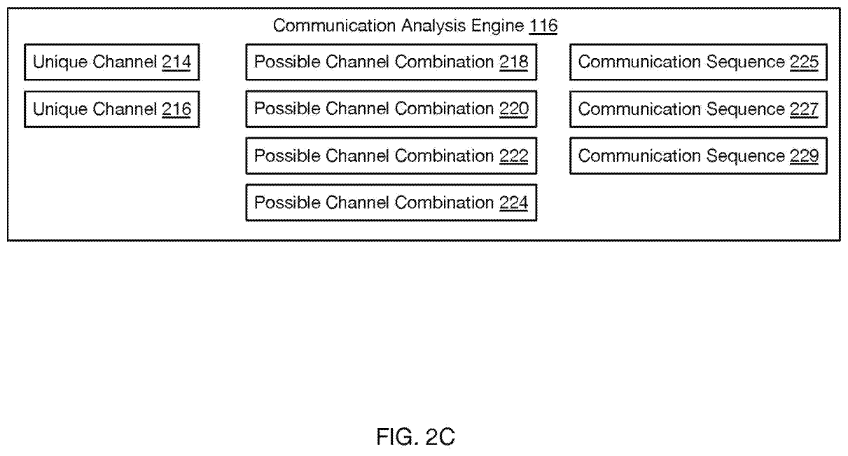

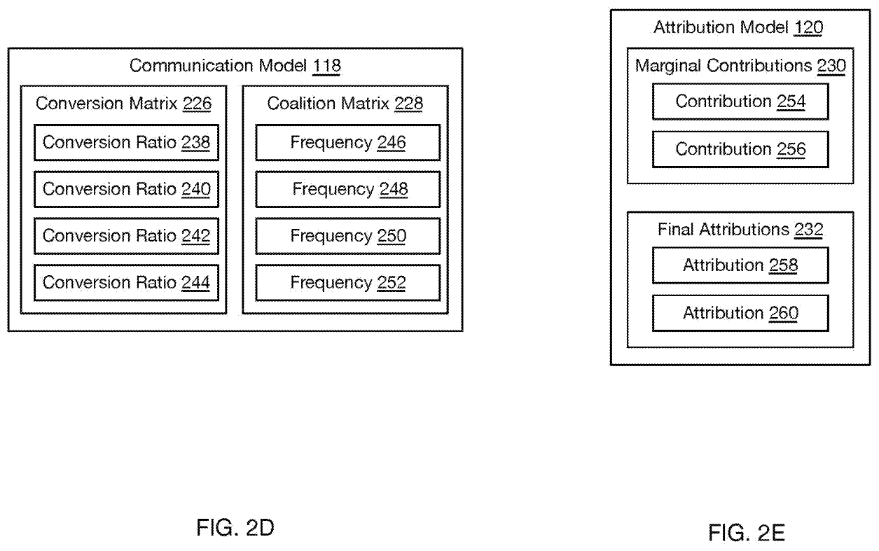

The above-described operations of the communication analysis engine 116, the communication model 118, the attribution model 120, the recommendation engine 122, and the communication details 124 may be utilized to derive optimized attributions and/or communication sequences for use in communicating with (e.g., presenting user communications to) one or more users via one or more content platforms 138 executing on computing devices 136. In particular, the optimized attributions and/or communication sequences may be used in communications between content services 130, 132 and users via content platforms 138. Non-limiting examples of the above-described operations are shown in FIGS. 2A-2E.

FIG. 2A illustrates a block diagram of a database 202 storing user communication data according to an exemplary embodiment of the present disclosure. The database 202 may be an exemplary implementation of a database 128 stored in the memory 110 of the computing device 102. Additionally or alternatively, the database 202 may be stored on another computing device that is communicatively coupled to the computing device 102, such as a server computing device that is communicatively coupled to one of the one or more networks 134. The database 202 stores data regarding user communications 206, 208, 210 associated with a particular user outcome 204. The user communications 206, 208, 210 may represent individual communications with a particular user via a particular communication channel (e.g., a content platform). The user communications 206, 208, 210 may each correspond to an individual piece of content presented to the corresponding user and/or to any other individual communication with the user. The user communications 206, 208, 210 may be stored in association with the corresponding user outcome 204.

The user outcome 204 may include one or more actions taken by the corresponding user, information received from a corresponding user, and/or results obtained relative to a corresponding user. In various implementations, the user outcome 204 may include one or more of a product purchased by a user, a retail purchase completed by the user column a service purchase by a user, a user registration completed by the user, and/or a newsletter sign-up for the user. In certain implementations, user communications 206, 208, 210 corresponding to the same user outcome 204 may be identified based on the contents of the user communications 206, 208, 210. For example, the user communications 206, 208, 210 may concern the same product and/or brand and may be associated with the same user as one another. Accordingly, any user outcome 204 that corresponds to the same product or brand and user as a plurality of user communications 206, 208, 210 may be identified as corresponding to those user communications 206, 208, 210. In certain instances, a time restriction may be applied to corresponding user outcomes 204. For example, corresponding user outcomes 204 may be identified as outcomes occurring within a predetermined time frame (e.g., within one day of one another, within one week of one another, within two weeks of one another, within one month one another, within six months of one another, within one year of one another) as one or more user communications 206, 208, 210. In still further implementations, corresponding user outcomes 204 may be identified by one or more forms of predictive analytics trained to analyze user communication information. For example, the corresponding user outcomes 204 may be identified by a machine learning model trained to identify user communications that correspond to the same user end product.

Information regarding the user outcome 204 may be received from a platform or location in which the user outcome 204 occurred. For example, where the user outcome 204 is a purchase completed via a website, the user outcome 204 may be received from a merchant platform used to complete that purchase. Additionally or alternatively, depending on the type of user outcome 204, the user outcome 204 may similarly be received from a brick-and-mortar retail purchase point of sale (POS) system, a customer relationship management (CRM) system, a mailing list management platform, and the like.

FIG. 2B illustrates a block diagram of a user communication 206 according to an exemplary embodiment of the present disclosure. The user communication 206 depicted in FIG. 2B may be an exemplary implementation of the user communication 206 contained within the database 202. The user communication 206 includes communication details 262, product data 264, and user data 266. The communication details 262 may contain information regarding an individual communication with a particular user. The individual communication may include presenting a piece of content to a user, such as audio content, text content, video content, and/or image content. In certain instances, the content presented to the user may be presented by a content platform, such as Facebook®, Instagram®, TikTok®, YouTube®, Twitter®, or any other online content platform. In certain instances, the communication may include presenting a requested piece of content to user (e.g., requested audio and video content). In additional or alternative implementations, presented content may include inserting one or more pieces of content into other content that is requested by the user. For example, inserting content may include advertisements that are presented before, during, and/or after requested audio and/or video content. Additionally or alternatively, inserting content may include adding content to a timeline of other pieces of content within a feed (e.g., a social media feed) accessed by the user. The feed of content may include certain types of content (e.g., textual content, audio content, video content, image content, and combinations thereof). The content inserted as part of the user communication may be the same type of content as what is normally found in the user's feed (e.g., text content in a feed containing text content, image content in a feed containing image content, video content in a feed containing video content, audio content in a feed containing audio content, and combinations thereof). In one specific implementation, presenting the content to the user may include presenting advertisements to the user.

Accordingly, the communication details 262 may include various details regarding how the communication was presented to the user. As depicted, the communication details 262 may include one or more of a communication identifier, a channel for the communication, a communication type, a user identifier, a time for the communication, an outcome identifier, a value of the corresponding outcome, and/or a mode of conversion. The communication identifier may include a unique identifier (e.g., a unique alphanumeric identifier) of the user communication 206. As depicted, the communication identifier for the user communication 206 is 183956. The channel may include a communication channel by which the user communication 206 was presented. For example, the user communication 206 may have occurred via an online video platform, such as YouTube®. The communication type may specify a type of communication and/or a type of content presented to the user via the user communication 206. For example, the user communication 206 may be a pre-roll video advertisement that occurs before a requested piece of content on the online video platform. The user identifier may include a unique identifier (e.g., a unique alphanumeric identifier) of the user with which the user communication 206 occurred. The user identifier may be a user identifier associated with the channel for the user communication 206. As depicted, the user identifier is 83740. The time may indicate a time at which the user communication 206 occurred (e.g., when corresponding content was presented to the user). As depicted, the time is Aug. 18, 2022 at 3:45 PM Eastern Time. The outcome identifier may include a unique identifier (e.g., a unique alphanumeric identifier) of the resulting outcome from the user communication 206. For example, the user communication 206 may be the final communication before the user outcome 204, and the outcome identifier may include a unique identifier of the user outcome 204. As depicted, the outcome identifier is 98427. The outcome value may indicate a value generated by the user outcome 204. For example, the outcome value may represent a financial or monetary value of a sale made to the user. Additionally or alternatively, the outcome value may indicate an expected or predicted lifetime value (e.g., of a recurring service that the user signed up for). As depicted, the outcome value is $400. It is noted that while FIG. 2B depicts the outcome value as being a monetary amount, outcome values may also be associated with non-monetary values or amounts (e.g., a value indicating the user did or did not sign up for a mailing list, etc.). The mode of conversion may indicate how the user was converted into a desired outcome (e.g., the user outcome 204). For example, the mode of conversion may indicate how the user transitioned from the user communication 206 to performing and completing the user outcome 204. For example, the user may have clicked on the pre-roll advertisement on the online video platform, so the mode of conversion may indicate clickthrough.

The product data 264 may indicate information regarding the goods or services corresponding to the user communication 206. For example, the user communication 206 may be a purchase or subscription made by the corresponding user. The product data 264 may accordingly indicate what product and/or service was purchased or subscribed to by the corresponding user. For instance, the product data 264 may identify one or more of a product category and/or a product name. In additional or alternative implementations, the product data 264 may include a service category, a service plan, a term for which the corresponding user is subscribed, and/or other information regarding the product and/or service that was purchased or subscribed to. In one specific example, the user communication 206 may have resulted in a corresponding user purchasing a camera lens. Accordingly, the data 264 may include a product category indicating camera and a product name indicating camera lens (e.g., a specific make and model of the purchased camera lens). Other product categories may include one or more audio products, camera products, car electronic products, gaming products, wearables products, clothing products, digital services, medical services, and the like. As another example (not depicted), the user communication 206 may correspond to a brand advertisement (e.g., advertising a certain brand/or product line sold by a particular brand, but not corresponding to any particular, individual product). In such instances, the product data 264 may include information regarding the corresponding brand and/or product line, but may not specifically identify a particular good or service. Similarly, product data 264 may be included for user communication 206 that necessarily results in a sale or purchase by a corresponding user. For example, product data may be included for advertisements for specific products, even when the user does not click through to purchase the specific product.

The user data 266 may contain information regarding the corresponding user for the user communication 206. In particular, where the user communication 206 involves presenting one or more pieces of content to a user, the user data 266 may provide information regarding the user to which the content was presented during the user communication 206. In certain implementations, the user data 266 may individually identify the user. In additional or alternative implementations, the user data 266 may identify the user as part of a cohort or other collection of users. For example, the user data 266 contains a user ID 83740, which may individually correspond to the user and/or which may respond to a cohort of users to which the corresponding user belongs. Additionally, the user data 266 contains location information for the user (New York City) and age information for the user (age 25-30). It should be appreciated that, in various implementations, the user data 266 may contain additional or alternative information. For example, the user data 266 may contain one or more of a name of the user, an address of the user, a user account for the user, previous purchases made by the user, previous content presented to the user, user preferences, and the like.

The user communication 206 as described above and depicted in FIG. 2B is an exemplary implementation of the user communications that may be received and analyzed by the computing device 102. It should be understood that, in practice, other implementations may differ. For example, additional or alternative implementations may omit one or more pieces of information described above and/or may include one or more pieces of additional information not described above. As a specific example, where no user outcome is performed as a direct result of the user communication 206, the communication details 262 may omit certain information (e.g., outcome identifier, outcome value, mode of conversion). Furthermore, the structure of the user communication 206 data may differ in various implementations. For example, rather than being stored as a single user communication 206, the communication details 262, product data 264, and user data 266 may be stored as multiple entries in the database and/or may be stored across multiple databases. As a specific example, the user data 266 may not always be stored within the user communication 206. In particular, the user communication 206 may store the user identifier, but may omit the remainder of the user data 266. In such a case, the user ID may be used to access the remainder of the user information within a separate database (e.g., within a user database).

FIG. 2C illustrates a block diagram of a communication analysis engine 116 for analyzing user communication data according to an exemplary embodiment of the present disclosure. The communication analysis engine 116 may be configured to analyze a collection of data regarding one or more user communications 206, 208, 210 and one or more user outcomes 204 to identify unique channels 214, 216, possible channel combinations 218, 220, 222, 224, and/or communication sequences 225, 227, 229. The communication analysis engine 116 may be configured to analyze user communications 206, 208, 210 across multiple users and multiple user outcomes 204 (e.g., multiple user outcomes 204 of the same type and/or multiple user outcomes 204 of different types). In an aspect, the user communications 206, 208, 210 may be associated with a common product, a common product class or product line, the same brand, and/or the same retailer. In certain implementations, the communication analysis engine 116 may receive the data for analysis from a user (e.g., in conjunction with a request to determine attributions for the corresponding user outcomes 204). In certain instances, the data received may include identifications of which user outcomes 204 correspond to which user communications 206, 208, 210. In additional or alternative implementations, the communication analysis engine 116 may be configured to identify corresponding user outcomes 204 according to one or more of the techniques discussed above. In additional or alternative implementations, the user communications 206, 208, 210 and/or the user outcomes 204 may be received from a database, such as the database 202.

The communication analysis engine 116 may be initially configured to identify one or more unique channels 214, 216 within the received data (e.g., by which one or more user communications 206, 208, 210 occurred). In particular, as discussed above, the user communications 206, 208, 210 may include communication details 262 that indicate information regarding the channel by which the corresponding user communication 206, 208, 210 occurred. The communication analysis engine 116 may be configured to analyze this information and identify how many and/or which unique channels were utilized to facilitate the user communications 206, 208, 210. For example, the communication analysis engine 116 may identify all unique channels 214, 216 through which user communications 206, 208, 210 occurred. Additionally or alternatively, the communication analysis engine 116 may identify only a subset of the unique channels 214, 216 within the received user communication data. For example, the communication analysis engine 116 may identify all unique channels 214, 216 with more than a predetermined threshold of communications (e.g., five communications, 10 communications, 50 communications, 100 communications). As another example, the communication analysis engine 116 may identify a predetermined quantity of unique channels 214, 216 (e.g., the top five unique channels 214, 216 with the most user communications, the top 10 unique channels 214, 216, the top 25 unique channels 214, 216, the top 50 unique channels 214, 216). Each unique channel 214, 216 may correspond to a communication channel by which a user communication 206, 208, 210 occurred. For instance, each unique channel 214, 216 may represent an online medium in which content is presented to users. For example, unique channels 214, 216 may include one or more of a text communication channel, an audio communication channel, a video communication channel, and combinations thereof. More specifically, unique channels may include specific websites and/or content platforms through which user communications occur. For example, the unique channels 214, 216 may include one or more social media platforms, content platforms (e.g., online video platforms, online audio platforms), podcast platforms, advertisement insertion platforms (e.g., ad insertion platforms for one or more websites, podcasts, applications, and the like), search result advertising platforms, other advertising platforms, and the like. Still further examples may include individual pieces of content (e.g., individual pieces of audio content, visual content, and/or text content containing brand/or other advertising information). In preferred implementations, the unique channels 214, 216 may include one or more of Facebook®, Instagram®, TikTok®, YouTube®, search engine result ads, website banner ads, dynamic ad insertion platforms, and the like.

In various implementations, the granularity and/or level of detail identified for each of the unique channels 214, 216 may be predetermined. In certain instances, the unique channels 214, 216 may be identified on a platform level. For example, user communications 206, 208, 210 that occur as advertisements on YouTube® may be identified by the unique channel 214, 216 as “YouTube®.” In additional or alternative instances, the unique channels 214, 216 may identify different types of advertisements within the same content platform. For example, user communications 206, 208, 210 that occur as advertisements on YouTube® may be identified with a different unique channel 214, 216 based on the type of advertisement, such as “YouTube®—pre-roll,”“YouTube®—post-roll advertisements,” “YouTube®—mid-roll advertisement,” and/or “YouTube®—banner advertisement.” As may be appreciated by one skilled in the art, various other implementations may use different levels of detail granularity for the unique channels 214, 216 identified by the communication analysis engine 116. For example, the unique channels 214 may be further divided based on website domains, content creators, individual content identifiers, individual websites, and the like.

After identifying the unique channels 214, 216, the communication analysis engine 116 may identify possible channel combinations 218, 220, 222, 224 for the unique channels 214, 216. The possible channel combinations 218, 220, 222, 224 may be generated to represent a possible combination of unique channels by which user communications 206, 208, 210 may be presented to the same individual (e.g., prior to the user outcome 204). In particular, the possible channel combinations 218, 220, 222, 224 may be identified to contain one or more of the unique channels 214, 216. In various implementations, the possible channel combinations 218, 220, 222, 224 may include all possible combinations of the unique channels 214, 216 (e.g., all 2^{N}−1 combinations, where N is the number of unique channels). In various other implementations, the possible channel combinations 218, 220, 222, 224 may only include a subset of all possible channel combinations. In certain implementations, the order in which the unique channels occur may not matter (e.g., may not be encoded or determined) for the possible channel combinations 218, 220, 222, 224. In additional or alternative implementations, the communication analysis engine 116 may be configured to identify various ordered sequences or ordered combinations of the unique channels 214, 216 as the possible channel combinations 218, 220, 222, 224. In one limited example for the purposes of illustration, the communication analysis engine 116 may identify three different unique channels 214, 216 within the user communications 206, 208, 210: Facebook® advertisements, Instagram® advertisements, and YouTube® advertisements. This results in a total of seven possible channel combinations 218, 220, 222, 224: Facebook® only; Instagram® only; YouTube® only; Facebook® and Instagram®; Facebook® and YouTube®; Instagram® and YouTube®; and all three of Facebook®, Instagram®, and YouTube®. In certain implementations, the possible channel combinations 218, 220, 222, 224 may be encoded as one or more binary vectors. For example, the possible channel combinations 218, 220, 222, 224 may be encoded with a binary indicator of the presence or absence of each of the unique channels 214, 216. As one specific example, the possible channel combination in the previous example for Facebook® and Instagram® may include a binary “1” corresponding to each of the Facebook® and Instagram® unique channels and a binary “0” indicator associated with the YouTube® channel.

The communication analysis engine 116 may then further analyze the user communications 206, 208, 210 to identify one or more communication sequences 225, 227, 229. The communication sequences 225, 227, 229 may identify one or more user communications 206, 208, 210 that correspond to the same user outcome. In certain instances, the received user communications 206, 208, 210 may themselves identify corresponding user outcomes 204. In such instances, the communication analysis engine 116 may be configured to identify the communication sequences 225, 227, 229 as user communications 206, 208, 210 that correspond to the same user outcome. In other instances, the communication analysis engine 116 may identify corresponding user outcomes 204 (e.g., according to the techniques discussed above). After identifying the corresponding user outcomes 204, the communication analysis engine 116 may then proceed with identifying the communication sequences 225, 227, 229.

The communication sequences 225, 227, 229 may, in certain implementations, be encoded as binary vectors. For example, the communication sequences 225, 227, 229 may be encoded as binary vectors with “1” values corresponding to the possible channel combination 218, 220, 222, 224 that matches the communication sequence 225, 227, 229. In one specific example, the communication sequence 227 may correspond to communications that occurred via Instagram® advertisements and YouTube® advertisements. In such instances, the communication sequence 227 may contain a “1” corresponding to the Instagram® and YouTube® possible channel combination. In certain instances, the communication sequences may be encoded with positive identifiers associated with each of the individual channels contained within. Continuing the previous example, in addition to the “1” associated with the YouTube® and Instagram® possible channel combination, the communication sequence 227 may additionally contain “1” values associated with each of the Instagram® only and YouTube® only possible channel combinations.

FIG. 2D illustrates a block diagram of a communication model 118 for determining conversions and/or coalitions of multiple communication channels according to an exemplary embodiment of the present disclosure. In particular, the communication model 118 may be generated to model different user outcome impacts for various channel combinations (e.g., identified by the communication analysis engine). In certain implementations, the communication model 118 may include one or more models, such as a conversion matrix 226 and a coalition matrix 228. The conversion matrix 226 may be computed to represent how frequently each unique channel occurs in communication sequences 225, 227, 229 that result in a desired user outcome (e.g., a “conversion”). For example, the desired user outcome may include one or more of a sale or subscription to a good or service, such as completing a sale of a good or service, completing a sign-up for a newsletter or customer loyalty program, receiving a positive product review from a user, receiving a social media follow from a user, and the like. In particular, the conversion matrix 226 may be computed to represent a percentage of the user outcomes 204 that represent the desired user outcome correspond to the various possible channel combinations 218, 220, 222, 224. To compute the conversion matrix 226, conversion ratios may be computed for at least a subset of the possible channel combinations 218, 220, 222, 224, and the conversion ratios may be stored within the conversion matrix 226. Conversion ratios 238, 240, 242, 244 may be computed based on the total number of times each respective possible channel combination 218, 220, 222, 224 corresponds to the desired user outcome. In one specific example, the conversion ratios 238, 240, 242, 244 may be computed as the percentage of occurrences for the desired user outcome in which the respective possible channel combination occurs. An entry may then be added to the conversion matrix 226 that corresponds to and includes the conversion ratio 238, 240, 242, 244 for the respective channel combination.

In certain implementations, the conversion ratio may be calculated by counting the number of times each unique channel 214, 216 occurs within all of the communication sequences 225, 227, 229 that correspond to a desired user outcome (e.g., COUNTᵢ for i=1 . . . N unique channels). The total count for all unique channels 214, 216 may then be summed to form a total conversion ratio (TCR) (e.g., TCR=Σᵢ₌₁^{N} COUNTᵢ). The conversion ratio (CR) for each unique channel 214, 216 may then be calculated as the ratio of the unique channel's count to the total conversion ratio (e.g., CRᵢ=COUNTᵢ/TCR for i=1 . . . N unique channels). Accordingly, the conversion matrix 226 may be a vector of size N, where N is the number of unique channels 214, 216.

As one illustrative example, the received user communication data may contain 32 communication sequences, 24 of which correspond to a desired user outcome (e.g., sale of a product or service). The remaining 8 may correspond to a different user outcome (e.g., an abandoned sale, a user leaving a newsletter or customer loyalty program). Of the 24 communication sequences that correspond to the desired user outcome, it may be determined that user communications on Facebook® occur 20 times, user communications on Instagram® occur 15 times, user communications on YouTube® occur 8 times, and user communications on Google® search advertisements occur 5 times. The total conversion ratio may then be computed as TCR=20+15+8+5=48. The conversion ratio for Facebook® may thus be computed as CR_{FB}=20/48=42%, the conversion ratio for Instagram® may thus be computed as CR_{IG}=15/48=31%, the conversion ratio for YouTube® may thus be computed as CR_{YT}=8/48=17%, and the conversion ratio for Google® may thus be computed as CR_{G}=5/48=10%. These conversion ratios may then be added to corresponding rows or columns of the conversion matrix 226 (e.g., as the conversion ratios 238, 240, 242, 244).

The coalition matrix 228 may be computed to represent how frequently at least a subset of the possible channel combinations occur (e.g., occur as communication sequences 225, 227, 229 associated with a desired user outcome). In particular, the coalition matrix 228 may contain frequencies 246, 248, 250, 252 corresponding to each of at least a subset of the possible channel combinations 218, 220, 222, 224. The frequencies 246, 248, 250, 252 may indicate a number of times and/or a percentage of times the corresponding possible channel combination 218, 220, 222, 224 occurs within communication sequences 225, 227, 229 that results in the desired user outcome. In certain implementations, the frequencies 246, 248, 250, 252 may be computed by, for each communication sequence 225, 227, 229 associated with the desired user outcome, adding a binary indicator to a corresponding row or column (e.g., a corresponding frequency 246, 248, 250, 252) of the coalition matrix 228. After iterating through all of the communication sequences 225, 227, 229 in this manner, the frequencies may thus accurately reflect the total number of occurrences for each of the corresponding possible channel combinations 218, 220, 222, 224. Thus, the coalition matrix 228 may be a vector of size 2^{N}−1, where N is the number of unique channels 214, 216.

Continuing the previous illustrative example, of the 24 communication sequences that correspond to the desired user outcome, it may be determined that 2 of the communication sequences include the only Facebook® channel combination, 1 of the communication sequences include the only Instagram® channel combination, 1 of the communication sequences include the only YouTube® channel combination, 8 of the communication sequences include the Facebook® and Instagram® channel combination, 3 communication sequences include the Instagram® and YouTube® channel combination, 6 communication sequences include the Facebook® and YouTube® channel combination, and 3 communication sequences include the Facebook®+Instagram®+YouTube® channel combination. Accordingly, after iterating through all 24 of the communication sequences as described above, the only Facebook® channel combination may have a frequency of 19, the only Instagram® channel combination may have a frequency of 15, the only YouTube® channel combination may have a frequency of 13, the Facebook® and Instagram® channel combination may have a frequency of 8, the Instagram® and YouTube® channel combination may have a frequency of 3, the Facebook® and YouTube® channel combination may have a frequency of 6, and the Facebook®+Instagram®+YouTube® channel combination may have a frequency of 3. These frequencies may be stored as corresponding frequencies 246, 248, 250, 252 within the coalition matrix 228.

FIG. 2E illustrates a block diagram of an attribution model 120 for determining attributions for multiple communication channels according to an exemplary embodiment of the present disclosure. Specifically, the attribution model 120 may be computed to indicate what proportion of a corresponding user outcome 204 should be attributed to each of the communication channels utilized prior to that user outcome (e.g., each of the communication channels contained within a corresponding communication sequence 225, 227, 229). In particular, computing the attribution model 120 may ultimately result in computing final attributions 232 for the unique channels 214, 216. In particular, the final attributions 232 may include individual attributions 258, 260 corresponding to each of the unique channels 214, 216. The attributions 258, 260 indicate the relative percentage of a corresponding type of outcome (e.g., a corresponding desired user outcome) that should be attributed to each of the unique channels 214, 216. In particular, the attributions 258, 260 may be computed to determine attributions from multiple occurrences of user outcomes (e.g., multiple occurrences of one or more desired user outcomes) and may be computed to indicate each unique channel's 214, 216 contribution to the overall share of the desired user outcomes. In one specific example, the desired user outcome may be the sale of a product or service, and multiple sales may be completed via user communications 206, 208, 210 with multiple users that occurred across multiple unique channels 214, 216 (e.g., sponsored content on YouTube®, Facebook® timeline advertisements, Instagram® timeline advertisements, YouTube® video advertisements, and sponsored Instagram® posts). In such instances, the attributions 258, 260 may be computed to determine the relative impact of each of these channels 214, 216 on the overall number of sales completed (e.g., a percentage of the total sales amount that should be attributed to content presented by each of the unique channels 214, 216).

In certain implementations, prior to computing the final attributions 232, marginal contributions 230 may be computed for each of the unique channels 214, 216. The marginal contributions 230 may contain contributions 254, 256 that correspond to each of at least a subset of the unique channels 214, 216. The contributions 254, 256 may be computed to indicate the marginal contribution to a corresponding user outcome (e.g., to a desired user outcome) based on user communications that occurred via the corresponding unique channel 214, 216. Stated differently, the contributions 254, 256 may represent an estimated measure of how much additional value (e.g., in dollars) or how much improved sales (e.g., in number of increased sales and increased likelihood of completing a sale) is generated based on user communications 206, 208, 210 that occur via the corresponding unique channel 214, 216.

In a preferred embodiment, the marginal contributions 254, 256 may be computed as Shapley values for the corresponding unique channels 214, 216. In particular, a worth matrix (WrM) may be calculated that adds together the conversion ratios for each of the unique channels within corresponding possible channel combinations. For example, the worth matrix may be calculated by taking the dot product of a binary square matrix (BM) of size N and the conversion matrix (ConvM) (e.g., WrM=BM*ConvM). A subset of the entries in the worth matrix may be removed (e.g., the subset of entries with length 1 may be removed). A weight matrix (WtM) may be computed based on the frequency for each unique channel 214, 216 (denoted kᵢ). In particular, the weights may be calculated as:

$$WtM [ i ] = \frac{k ! * ( N - k - 1 ) !}{N !}$$

for i=1 . . . N.

A contribution matrix (ContM) may be calculated as an initial estimate of the marginal contributions for each of the unique channels. For example, the contribution matrix may be calculated based on the worth matrix and the coalition matrix (CoalM). In one specific implementation, the contribution matrix may be calculated as:

ContM[i]=WrM[CoalM[i]]−WrM[CoalM[A]],
for i=1 . . . N, where A represents the unique channels excluding channel i.

Shapley values may then be calculated based on the weight matrix for each unique channel and stored as a Shapley matrix (SM). Specifically, the Shapley values may be calculated as:

$$S M [ i ] = ( WtM [ i ] * ContM [ i ] ) + \frac{WrM [ CoalM [ i ] ]}{N}$$

where SM[i] is the Shapley value for channel i from i=1 . . . N. The Shapley matrix may be a representative implementation of the marginal contributions 230, with the Shapley values being representative implementations of the contributions 254, 256.

The final attributions 232 may then be calculated based on the marginal contributions 230. In particular, the final attributions 232 may be calculated based on the communication model 118 and the marginal contributions 230. In certain implementations, the final attributions 232 may be calculated based on the marginal contributions 230 and the conversion matrix 226. For example, in certain implementations, an initial allocation matrix (IAM) may be calculated based on the conversion matrix, and the final allocations may be calculated based on the marginal contributions 230 (e.g., the Shapley matrix) and the initial allocation matrix. Specifically, the initial allocation matrix (IAM) may be calculated as:

IAM[i]=ConvM[i]/TCR
and the final attributions 232 may be calculated as a final attribution matrix (FAM), where:

$$FAM [ i ] = \frac{IAM [ i ] + S M [ i ]}{200} * 100 \% ,$$

where FAM[i] represents the attribution 258, 260 for the corresponding unique channel i, as a percentage.

As explained further below, the final attributions 232 may be used in subsequent processing and/or may be transmitted to a user (e.g., a requesting user). For example, the final attributions 232 may be transmitted to a user in charge or requesting, purchasing, or otherwise coordinating user communications such as advertisement presentations across the unique channels 214, 216. In one example, the final attributions 232 may be used to calculate budgets for the unique channels (e.g., how much money should be spent purchasing user communications via each of the unique channels). In one implementation, per-channel cost data may be received (e.g., from a user, from a database, from an application programming interface (API) query) and may be used to calculate the per channel budgets. A weighted cost matrix (WCM) may be calculated based on the cost data and the final attributions 232 as:

WCM[i]=FAM[i]*Cost[i],
where Cost[i] is the cost per user communication for channel i from i=1 . . . N. Budget percentages (BP) may be calculated based on the weighted cost matrix as:

$$BP [ i ] = \frac{WCM [ i ]}{{\sum }_{i = 1}^{N} WCM [ i ]} * 100 \% .$$

The budget percentages for each channel may then be used to derive a total recommended impression budget per channel (e.g., by multiplying each of the budget percentages by a total desired spend received from a user).

Additionally or alternatively, the final attributions 232 may be used (e.g., by the recommendation engine 122) to generate an optimized channel sequence, which may identify one or more optimal channel sequences (e.g., ordered sequences and/or unordered sequences) for the unique channels 214, 216 that maximize the likelihood that the desired user outcome will occur. The optimized channel sequence may identify one or more of the top individual unique channels and/or top channel combinations (e.g., based on the coalition matrix) that are associated and/or correlated with the desired user outcome. Depending on the user communication data received, the optimized channel sequence may be generated on an overall basis (e.g., based on all of the received user communications 206, 208, 210 that resulted in the desired user outcome 204). Additionally or alternatively, the optimized channel sequence may be generated for individual users or for cohorts of users. For example, the user communication data received and used to generate the communication model 118 and/or the attribution model 120 may be divided on a per-user or per-cohort basis. In such instances, the above-described analysis may be repeated to generate multiple attributions and/or multiple optimized content sequences for each of the users and/or cohorts for which individualized user communication data is received.

Furthermore, one skilled in the art will appreciate that, while the above-described techniques are described as being performed to identify and attribute credit for desired outcomes (e.g., positive outcomes) to one or more unique channels, similar techniques may be used to identify and attribute credit for undesired outcomes (e.g., negative outcomes). In particular, the above analysis may be repeated for user communications associated with one or more undesired outcomes (e.g., a user abandoning a sale, a user leaving a newsletter or customer loyalty program, receiving a negative product review from a user, having a user unfollow a social media account). The attributions may then be used to identify which unique channels should be avoided.

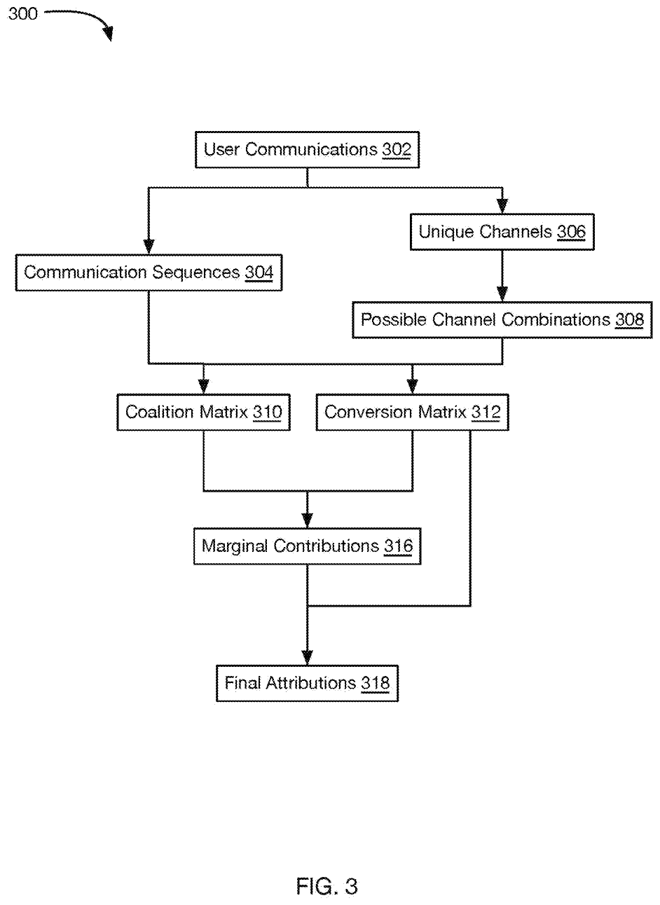

FIG. 3 illustrates a flow diagram 300 of operations to determine attributions of user outcomes for multiple communication channels according to an exemplary embodiment of the present disclosure. Specifically, the operations depicted in the flow diagram 300 may be performed to receive and analyze data regarding one or more user communications via multiple unique communication channels to determine final attributions 318 for each of at least a subset of the unique channels. As explained further above, the final attributions 318 may be computed to determine overall contributions of one or more unique channels, causing or otherwise increasing the likelihood of one or more desired user outcomes. The blocks in the flow diagram 300 may be representative implementations of one or more corresponding components or data structures discussed above. For example, the user communications 302 may be an exemplary implementation of the user communications 206, 208, 210, the communication sequences 304 may be an exemplary implementation of the communication sequences 225, 227, 229, the unique channels 306 may be an exemplary implementation of the unique channels 214, 216, the possible channel combinations 308 may be an exemplary implementation of the possible channel combinations 218, 220, 222, 224, the coalition matrix 310 may be an exemplary implementation of the coalition matrix 228, the conversion matrix 312 may be an exemplary implementation of the conversion matrix 226, the marginal contributions 316 may be an exemplary implementation of the marginal contributions 230, and/or the final attributions 318 may be an exemplary implementation of the final attributions 232.

The flow diagram 300 begins with receiving data regarding one or more user communications 302. The user communications 302 are to be analyzed to identify communication sequences 304 that correspond to the same user outcome (e.g., a particular outcome for a particular user based on one or more user communications 302). In certain instances, the communication sequences 304 may concern the same type of outcome (e.g., a product sale) and/or different types of user outcomes (e.g., some communication sequences 304 may correspond to product sales, other communication sequences 304 may correspond to newsletter sign-ups). User communications 302 may also be analyzed to identify unique channels 306 by which the user communications 302 occurred. The unique channels 306 may then be used as the basis to determine multiple possible channel combinations 308.

As explained further above, the communication sequences 304 and the possible channel combinations 308 may then be used to generate the coalition matrix 310 and the conversion matrix 312. For example, the coalition matrix 310 may be determined based on how frequently each of the possible channel combinations 308 occur within communication sequences 304 corresponding to a desired outcome. As another example, the conversion matrix 312 may be determined based on how frequently each of the unique channels 306 occur in communication sequences 304 that correspond to a desired outcome. The coalition matrix in the conversion matrix may then both be used to determine marginal contributions 316. In particular, the marginal contributions 316 may be computed as Shapley values for each of the unique channels 306 based on the coalition matrix 310 and the conversion matrix 312. The marginal contributions may then be used as a basis for computing the final attributions 318 for the unique channels 306, as described further above.

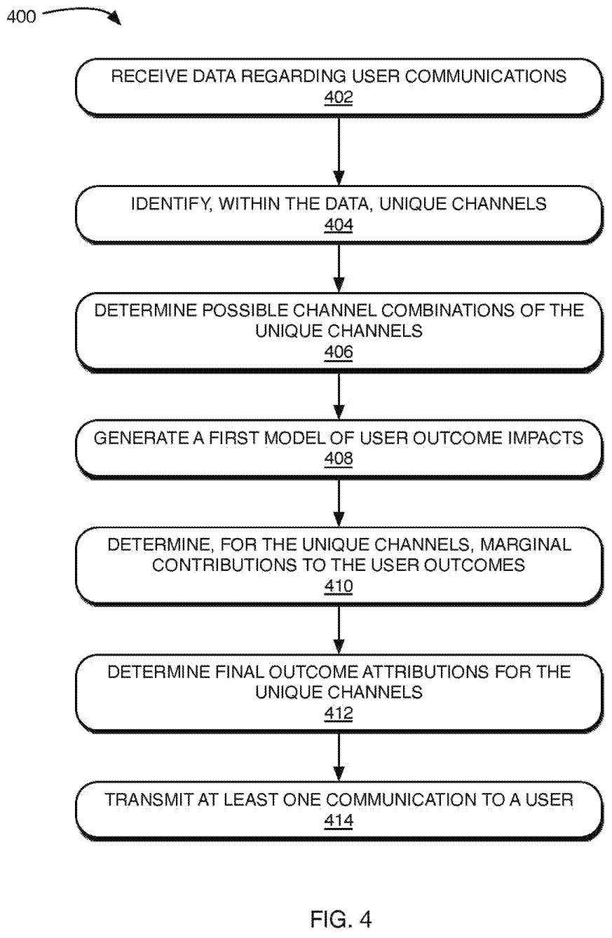

FIG. 4 illustrates a flow diagram of a method 400 to determine attributions of user outcomes according to an exemplary embodiment of the present disclosure. The method 400 may be implemented on a computer system, such as the system 100. For example, the method 400 may be implemented by the computing devices 102, 104, 106, 136. The method 400 may also be implemented by a set of instructions stored on a computer readable medium that, when executed by a processor, cause the computing device to perform the method 400. For example, all or part of the method 400 may be implemented by the processor 108 and the memory 110. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks may be optional.

The method 400 may begin with receiving data regarding user communication (block 402). For example, data may be received regarding multiple user communications 206, 208, 210, 302. The data may be received from a user, such as a user that has submitted a request for attribution analysis of user outcomes across various communication channels. In certain instances, the data may additionally or alternatively be retrieved from a database 128, 202. In certain instances, user communications 206, 208, 210 contained within the data may include one or more of communication details 262, product data 264, and user data 266. In instances where the user communication 206, 208, 210 resulted in a particular user outcome 204 (e.g., completing a sale of a good or service, completing a sign-up for a newsletter or customer loyalty program, receiving a positive product review from a user, receiving a social media follow from a user, and the like), the user communication 206, 208, 210 may include information regarding the user outcome 204 (e.g., a type of the user outcome, an outcome value, a specific outcome identifier).

Unique channels may be identified within the data (block 404). For example, the user communications 206, 208, 210 contained within the received data may have occurred across multiple communication channels, and in certain instances, multiple user communications associated with the same user outcome 204 may have occurred by at the same communication channel. Accordingly, unique channels 214, 216, 306 may be identified to include all of or at least a subset of the unique communication channels by which the received user communications 206, 208, 210 occurred. The unique channels 214, 216, 306 may be identified by analyzing each of the user communications 206, 208, 210 and identifying a communication channel for each user communication 206, 208, 210. Unique channels 214, 216, 306 may then be identified based on the corresponding communication channels, as explained above.

Possible channel combinations may be determined for the unique channels (block 406). For example, the computing device 102 may determine possible channel combinations 218, 220, 222, 224, 308 for the unique channels 214, 216, 306. As explained above, the possible channel combinations 218, 220, 222, 224, 308 may be determined to include all possible combinations of one or more of the unique channels 214, 216, 306. In certain implementations, the order in which the unique channels 214, 216, 306 occur within the possible channel combinations 218, 220, 222, 224, 308 may matter (e.g., may be encoded within the possible channel combinations 218, 220, 222, 224, 308). In other implementations, the order of the unique channels 214, 216, 306 may not matter and may accordingly not be encoded within the possible channel combinations 218, 220, 222, 224, 308.

A first model of user outcome impacts may be generated (block 408). For example, the computing device 102 may generate a communication model 118, which may measure how frequently various unique channels and combinations thereof were associated with one or more desired user outcomes (e.g., contained within communication sequences 225, 227, 229 associated with one or more desired user outcomes). The communication model 118 may include a conversion matrix 226 and/or a coalition matrix 228. The conversion matrix 226 and/or the coalition matrix 228 may be calculated as described further above.

Marginal contributions to the user outcomes may be determined for the unique channels (block 410). For example, the computing device 102 may determine marginal contributions 230, 316 to one or more desired user outcomes for at least a subset of the unique channels 214, 216, 306. The marginal contributions 230, 316 may be determined based on the coalition matrix 310 and/or the conversion matrix 312. As explained further above, the marginal contributions 230, 316 may include contributions 254, 256, which may be computed as Shapley values for corresponding unique channels 214, 216, 306.

Final outcome attributions may then be determined for the unique channels (block 412). For example, the computing device 102 may determine final attributions 232 for the unique channels 214, 216, 306. The final attributions 232, 318 may be computed based on the marginal contributions 316. In particular, the final attributions 232 may include attributions 258, 260 corresponding to particular unique channels 214, 216, 306 that indicate a percentage of the desirable user outcomes attributable to the corresponding unique channel 214, 216, 306.

At least one communication may be transmitted to a user (block 414). For example, the computing device 102 may transmit at least one communication to another computing device associated with a user, such as a user requesting the attribution analysis and/or providing the user communication data. The at least one communication may include the final attributions 232. In additional or alternative implementations, the communication may include one or pieces of additional information, such as a proposed budget allocation for the unique channels 214, 216, 306 and/or an optimized channel sequence for the unique channels 214, 216, 306, which may be determined as explained further above. In certain implementations, one or more automated actions may be taken based on the at least one communication. For example, in certain implementations, the proposed budget allocation may be used to perform one or more automated purchases of user communications (e.g., via one or more application programming interfaces for at least a subset of the unique channels 214, 216, 306). Additionally or alternatively, the optimized channel sequence may be used to deliver improved content to individual users and/or to cohorts of users, as explain above.

In this manner, the method 400 may enable the improved attribution of particular user outcomes (e.g., desired user outcomes, undesired user outcomes) to particular communication channels. Improved attribution in this manner may enable the generation of optimized channel sequences and/or optimized strategies for presenting communications and content to users. This may reduce overall communication and networking overhead, as desired user outcomes can be reached with fewer individual user communications. Additionally, this may reduce the overall cost (e.g., in purchased user communications) to achieve one or more desired user outcomes, as improved budgets may be generated based on higher-quality channel attributions.

Furthermore, the optimized communication sequences may be used to structure communications with individual users and/or individual cohorts of users across multiple communication channels. For example, the optimized channel sequence may indicate that user communications via a first communication channel (e.g., YouTube® advertisements) are significantly more likely to convert to a desired user outcome (e.g., a product sale) when followed by communications via a second communication channel (e.g., Google® search result advertisements). In such instances, requests may be made to certain platform-controlling parties to structure user communications and/or to present content to users via the particular specified sequence. In particular, a request may be made via a Google® advertising platform (which also controls advertisements for subsidiary entity YouTube®) to present related user communications via Google® search result advertisements after a particular user is presented with a YouTube® advertisement for the same product. In response, the Google® advertising platform may, after presenting a YouTube® advertisement to the user, schedule delivery of a communication via Google® search result advertisements regarding the same product. In this manner, not only can the techniques disclosed herein be used to accurately quantify or attribute the impact of each communication with a communication sequence on achieving a target outcome and use such attributions to identify optimal communication sequences across different communication channels and platforms, but may also coordinate with various communication platforms to control implementation of the optimized sequences. As can be appreciated from the discussion above, such optimized sequences and enforcement mechanisms may be applied on an individual or per user basis or may be applied based on another criterion (e.g., demographics, location, etc.), thereby providing both fine-grained (e.g., individual user-based control) and coarse grained (e.g., criterion-based control) mechanism for leveraging the optimized communication sequences enabled by the accurate quantification or attribution techniques disclosed herein.

Similar techniques (e.g., similar modeling techniques) may be used to attribute factors other than user communications to one or more desired user outcomes. For example, different combinations of user interface layouts, user interface contents, and the like may be similarly attributed to one or more desired (or undesired) user outcomes using similar techniques (e.g., communication models and/or attribution models). In such instances, the attributions may be used to automatically finalize and/or alter other aspects of the user experience.

All of the disclosed methods and procedures described in this disclosure can be implemented using one or more computer programs or components. These components may be provided as a series of computer instructions on any conventional computer readable medium or machine-readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving data regarding user communications associated with user outcomes;
identifying, within the data, unique channels through which content of the user communications was presented;
determining possible channel combinations of the unique channels;
generating a first model of user outcome impacts for at least a subset of the possible channel combinations, wherein the first model comprises a conversion matrix corresponding representing conversion ratios for the unique channels and a coalition matrix representing a frequency of occurrence for the unique channels;
determining, for the unique channels, marginal contributions for the user outcomes based on the first model, wherein, for each respective unique channel, the marginal contributions represent a percentage of credit attributable to the respective unique channel for the user outcomes;
determining final outcome attributions for the unique channels based on the marginal contributions and the first model; and
transmitting, over a network, at least one communication to a user device based on the final outcome attributions.

2. (canceled)

3. The method of claim 1, wherein the marginal contributions are determined as Shapley values for the unique channels.

4. The method of claim 1, wherein generating the first model further comprises:
determining the conversion ratios for the unique channels, wherein the conversion ratios represent a percentage of the user outcomes that include at least a subset of the channel combinations.

5. The method of claim 4, wherein the conversion ratios are stored in the conversion matrix, wherein the conversion matrix is created by:
identifying, for each user outcome, which channel combination is indicated by corresponding user communications;
determining, for each respective unique channel, the conversion ratio for the respective channel combination based on a total number of times the respective channel combination is identified; and
adding, for each respective channel combination, an entry to the conversion matrix indicating the conversion ratio for the respective channel combination.

6. The method of claim 1, wherein generating the first model further comprises:
creating the coalition matrix based on the user communications.

7. The method of claim 6, wherein determining the coalition matrix comprises, for each user outcome within the data, adding a binary indicator to the coalition matrix for each unique channel and channel combination present within corresponding user communications.

8. The method of claim 1, wherein at least a subset of the user communications are grouped into communication sequences, and wherein each communication sequence includes multiple customer communications that correspond to a single occurrence of a desired user outcome.

9. The method of claim 1, wherein transmitting the at least one communication to the user comprises:
computing a budget allocation for future user communications based on cost data for the unique channels and the final outcome attributions; and
transmitting the budget allocation to the user.

10. The method of claim 1, wherein transmitting the at least one communication to the user comprises:
determining an optimized channel sequence for the unique channels to facilitate a desired user outcome; and
transmitting the optimized sequence to the user.

11. The method of claim 10, wherein the optimized channel sequence is used to schedule content delivery to a user device.

12. The method of claim 1, wherein the content includes at least one of video content, image content, text content, and/or audio content.

13. The method of claim 1, wherein the user outcomes include at least one of a physical goods purchase, a digital goods purchase, a digital service subscription, and/or a user sign-up.

14. The method of claim 13, wherein the data includes communication details for corresponding content, product data for products purchased, and demographic data for associated users.

15. The method of claim 1, wherein a unique channel represents an online medium in which content is presented to users.

16. The method of claim 13, wherein the unique channels include at least one of social media timelines, content platforms, search engine results, and/or website content.

17. The method of claim 1, wherein the user outcomes concern at least one of a same product, a same brand, and/or a same advertising campaign.
